(19) United States
(12) Patent Application Publication
(10) Pub. No.: US 2025/0110580 A1
(43) Pub. Date: Apr. 3, 2025

(54) OPTICAL SENSING OF TRANSLATIONAL AND ROTATIONAL SHAFT MOVEMENTS

(71) Applicant: Apple Inc., Cupertino, CA (US)

(72) Inventors: Peng Zhao, Redwood City, CA (US); David D. Dashevsky, San Jose, CA (US); Mieczyslaw M. Dabrowski, San Francisco, CA (US)

(21) Appl. No.: 18/733,704

(22) Filed: Jun. 4, 2024

Related U.S. Application Data
(60) Provisional application No. 63/541,246, filed on Sep. 28, 2023.

(51) Int. Cl. G06F 3/03

(52) U.S. Cl. CPC G06F 3/0312

(57) ABSTRACT

An assembly includes a rotatable and translatable input device having an axis of rotation, a circumference about the axis of rotation, and an optical encoder pattern disposed around the circumference. The optical encoder pattern includes a series of polygon facets about the circumference and a one-dimensional substantially retroreflective feature parallel to the axis of rotation. The assembly further includes an optical emitter configured to emit electromagnetic radiation toward the optical encoder pattern, and an optical receiver including a two-dimensional array of pixels. The optical receiver is configured to receive reflections of the emitted electromagnetic radiation from the optical encoder pattern and generate an irradiance pattern in response to the reflections. The optical emitter and the optical receiver are disposed along a sensing axis orthogonal to the axis of rotation.

### CROSS-REFERENCE TO RELATED APPLICATION

This application is a nonprovisional and claims the benefit under 35 U.S.C. § 1.119(e) of U.S. Provisional Patent Application No. 63/541,246, filed Sep. 28, 2023, the contents of which are incorporated herein by reference as if fully disclosed herein.

### FIELD

The described embodiments generally relate to sensing translational and rotational shaft movements and, more particularly, to optically sensing translational and rotational shaft movements.

### BACKGROUND

Many of today's devices include a user-operable input device, such as a button, crown, dial, or knob. Some of the devices that may include such an input device include wearable devices (e.g., wrist-worn devices, headsets, or earphones), a game controller, a dashboard, or any other type of device (e.g., another type of portable, wearable, movable, or stationary device). Some input devices may only rotate or translate. Other input devices may both rotate and translate. A device that includes a rotatable and translatable input device needs a way to sense when the input device has been rotated or translated.

### SUMMARY

Embodiments of the systems, devices, methods, and apparatus described in the present disclosure employ optical sensing to detect (or track) translational and rotational movements of a shaft, such as a shaft that forms part of an input device.

In a first aspect, the present disclosure describes an assembly for an electronic device. The assembly may include a rotatable and translatable input device having an axis of rotation, a circumference about the axis of rotation, and an optical encoder pattern disposed around the circumference. The optical encoder pattern may include a series of polygon facets about the circumference and a one-dimensional substantially retroreflective feature parallel to the axis of rotation. The assembly may further include an optical emitter configured to emit electromagnetic radiation toward the optical encoder pattern, and an optical receiver including a two-dimensional array of pixels. The optical receiver may be configured to receive reflections of the emitted electromagnetic radiation from the optical encoder pattern and generate an irradiance pattern in response to the reflections. The optical emitter and the optical receiver may be disposed along a sensing axis orthogonal to the axis of rotation.

In a second aspect, the present disclosure describes another assembly for an electronic device. The assembly may include a rotatable and translatable shaft having an optical encoder pattern disposed around a circumference of the shaft; an optical emitter configured to emit electromagnetic radiation toward the optical encoder pattern; and an optical receiver including a two-dimensional array of pixels. The optical receiver may be configured to receive reflections of the emitted electromagnetic radiation from the optical encoder pattern and generate an irradiance pattern in response to the reflections. The irradiance pattern may have a centroid that moves along a first axis with respect to the two-dimensional array of pixels in response to a translation of the shaft along an axis of rotation, and the irradiance pattern may move along a second axis with respect to the two-dimensional array of pixels in response to a rotation of the shaft about the axis of rotation.

In a third aspect, the present disclosure describes another assembly for an electronic device. The assembly may include a rotatable and translatable shaft having an optical encoder pattern disposed around a circumference of the shaft; an optical emitter configured to emit electromagnetic radiation toward the optical encoder pattern; and an optical receiver including a two-dimensional array of pixels. The optical receiver may be configured to receive reflections of the emitted electromagnetic radiation from the optical encoder pattern and generate an irradiance pattern in response to the reflections. The irradiance pattern may have an electromagnetic radiation distribution that changes along a first axis with respect to the two-dimensional array of pixels in response to a translation of the shaft along an axis of rotation, and the irradiance pattern may move along a second axis with respect to the two-dimensional array of pixels in response to a rotation of the shaft about the axis of rotation.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A and 1B show an example of a device that may include an assembly for optically sensing translational and rotational shaft movements;

FIGS. 2A-2F show an example assembly including a shaft, an optical emitter, and an optical receiver;

FIG. 3 shows an example optical element disposed between a shaft and an optical receiver of a first example assembly for optically sensing translational and rotational shaft movements;

FIG. 4A shows a shaft of the first example assembly for optically sensing translational and rotational shaft movements in a first translation position, and FIG. 4B shows the shaft in a second translation position;

FIG. 5 shows example changes of an irradiance pattern on a surface of an optical receiver, as may be induced by translation or rotation of the shaft shown in FIGS. 3, 4A, and 4B;

FIG. 6 shows an example profile of a one-dimensional substantially retroreflective feature for a second example assembly for optically sensing translational and rotational shaft movements;

FIG. 7A shows a shaft of the second example assembly for optically sensing translational and rotational shaft movements in a first translation position, and FIG. 7B shows the shaft in a second translation position;

FIG. 8 shows example changes of an irradiance pattern on a surface of an optical receiver, as may be induced by translation or rotation of the shaft shown in FIGS. 6, 7A, and 7B;

FIG. 9 shows an example optical element disposed between an optical emitter and a shaft of a third example assembly for optically sensing translational and rotational shaft movements; and

FIG. 10 shows an example block diagram of an electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

Described herein are assemblies that can be used to optically sense translational and rotational shaft movements (e.g., translational and rotational movements of a shaft on which a generally cylindrical optical encoder pattern is applied or formed, or to which a generally cylindrical optical encoder pattern is attached). In some embodiments, translational and rotational shaft movements may be sensed simultaneously. In some embodiments, the assembly may be associated with a rotatable and translatable (i.e., pressable and/or pullable) crown.

In addition to one sensing module being able to simultaneously sense both translations and rotations of a crown (or other input device, or other apparatus including a rotatable and translatable shaft), the assemblies described herein may provide improved tolerance to alignment and process variation, a reduction in sensing assembly size, a reduced assembly and/or sensing module cost, a reduced power consumption, and improved radio frequency (RF) immunity (e.g., improved signal-to-noise ratio (SNR)).

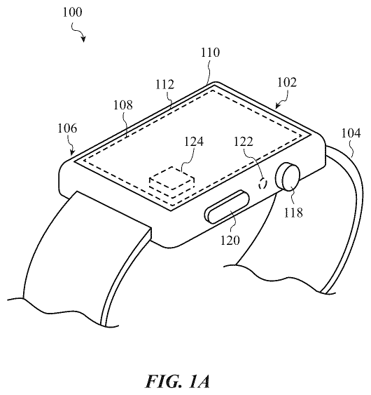

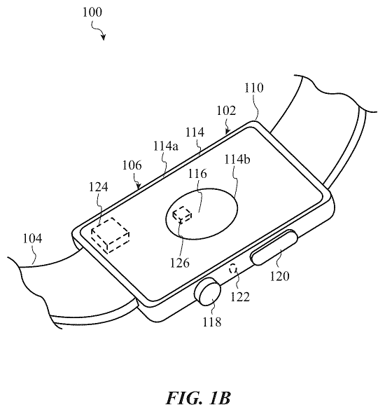

These and other systems, devices, methods, and apparatus are described with reference to FIGS. 1A-10. However, those skilled in the art will readily appreciate that the detailed description given herein with respect to these figures is for explanatory purposes only and should not be construed as limiting.

Directional terminology, such as “top”, “bottom”, “upper”, “lower”, “front”, “back”, “over”, “under”, “above”, “below”, “left”, “right”, etc. is used with reference to the orientation of some of the components in some of the figures described below. Because components in various embodiments can be positioned in a number of different orientations, directional terminology is used for purposes of illustration and is not always limiting. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

FIGS. 1A and 1B show an example of a device 100 (an electronic device) that may include an assembly for optically sensing translational and rotational shaft movements. The device's dimensions and form factor, and inclusion of a band 104 (e.g., a wrist band), suggest that the device 100 is an electronic watch, fitness monitor, or health diagnostic device. However, the device 100 could alternatively be any type of wearable device, including earphones or a headset. FIG. 1A shows a front isometric view of the device 100, and FIG. 1B shows a back isometric view of the device 100.

The device 100 may include a body 102 (e.g., a watch body). The body 102 may include an input or selection device, such as a crown 118 or a button 120. A band 104 may be attached to a housing 106 of the body 102 and may be used to attach the body 102 to a body part (e.g., an arm, wrist, leg, ankle, or waist) of a user. The body 102 may include a housing 106 that at least partially surrounds a display 108. In some embodiments, the housing 106 may include a sidewall 110, which sidewall 110 may support a front cover 112 (FIG. 1A) and/or a back cover 114 (FIG. 1B). The front cover 112 may be positioned over the display 108 and may provide a window through which the display 108 may be viewed. In some embodiments, the display 108 may be attached to (or abut) the sidewall 110 and/or the front cover 112. In alternative embodiments of the device 100, the display 108 may not be included and/or the housing 106 may have an alternative configuration.

The display 108 may include one or more light-emitting elements including, for example, light-emitting elements that define a light-emitting diode (LED) display, organic LED (OLED) display, liquid crystal display (LCD), electroluminescent (EL) display, or other type of display. In some embodiments, the display 108 may include, or be associated with, one or more touch and/or force sensors that are configured to detect a touch and/or a force applied to a surface of the front cover 112.

In some embodiments, the sidewall 110 of the housing 106 may be formed using one or more metals (e.g., aluminum or stainless steel), polymers (e.g., plastics), ceramics, or composites (e.g., carbon fiber). The front cover 112 may be formed, for example, using one or more of glass, a crystal (e.g., sapphire), or a transparent polymer (e.g., plastic) that enables a user to view the display 108 through the front cover 112. In some cases, a portion of the front cover 112 (e.g., a perimeter portion of the front cover 112) may be coated with an opaque ink to obscure components included within the housing 106. In some cases, all of the exterior components of the housing 106 may be formed from a transparent material, and components within the device 100 may or may not be obscured by an opaque ink or opaque structure within the housing 106.

The back cover 114 may be formed using the same material(s) that are used to form the sidewall 110 or the front cover 112. In some cases, the back cover 114 may be part of a monolithic element that also forms the sidewall 110. In other cases, and as shown, the back cover 114 may be a multi-part back cover, such as a back cover having a first back cover portion 114a attached to the sidewall 110 and a second back cover portion 114b attached to the first back cover portion 114a. The second back cover portion 114b may in some cases have a circular perimeter and an arcuate exterior surface 116 (i.e., an exterior surface 116 having an arcuate profile).

The front cover 112, back cover 114, or first back cover portion 114a may be mounted to the sidewall 110 using fasteners, adhesives, seals, gaskets, or other components. The second back cover portion 114b, when present, may be mounted to the first back cover portion 114a using fasteners, adhesives, seals, gaskets, or other components.

A display stack or device stack (hereafter referred to as a “stack”) including the display 108 may be attached (or abutted) to an interior surface of the front cover 112 and extend into an interior volume of the device 100. In some cases, the stack may include a touch sensor (e.g., a grid of capacitive, resistive, strain-based, ultrasonic, or other type of touch sensing elements), or other layers of optical, mechanical, electrical, or other types of components. In some cases, the touch sensor (or part of a touch sensor system) may be configured to detect a touch applied to an outer surface of the front cover 112 (e.g., to a display surface of the device 100).

In some cases, a force sensor (or part of a force sensor system) may be positioned within the interior volume below and/or to the side of the display 108 (and in some cases within the device stack). The force sensor (or force sensor system) may be triggered in response to the touch sensor detecting one or more touches on the front cover 112 (or a location or locations of one or more touches on the front cover 112), and may determine an amount of force associated with each touch, or an amount of force associated with the collection of touches as a whole. The force sensor (or force sensor system) may alternatively trigger operation of the touch sensor (or touch sensor system) or may be used independently of the touch sensor (or touch sensor system).

The device 100 may include various sensors. In some embodiments, the device 100 may have a port 122 (or set of ports) on a side of the housing 106 (or elsewhere), and an ambient pressure sensor, ambient temperature sensor, internal/external differential pressure sensor, gas sensor, particulate matter concentration sensor, or air quality sensor may be positioned in or near the port(s) 122.

In some cases, one or more skin-facing sensors 126 may be included within the device 100. The skin-facing sensor(s) 126 may emit or transmit signals through the housing 106 (or back cover 114) and/or receive signals or sense conditions through the housing 106 (or back cover 114). For example, in some embodiments, one or more such sensors may include a number of electromagnetic radiation emitters (e.g., visible light and/or IR emitters) and/or a number of electromagnetic radiation detectors (e.g., visible light and/or IR detectors, such as any of the electromagnetic radiation detectors described herein). The sensors may be used, for example, to acquire biological information from the wearer or user of the device 100 (e.g., a heart rate, respiration rate, blood pressure, blood flow rate, blood oxygenation, blood glucose level, and so on), or to determine a status of the device 100 (e.g., whether the device 100 is being worn or a tightness of the device 100).

The device 100 may include circuitry 124 (e.g., a processor and/or other components) configured to determine or extract, at least partly in response to signals received directly or indirectly from one or more of the device's sensors, and by way of example, biological parameters of the device's user, an input provided by the user, a status of the device 100 or its environment, and/or a position (or other aspects) of objects, particles, surfaces, or a user. The biological parameters may include, for example, a biometric, heart rate, respiration rate, blood pressure, blood flow rate, blood oxygenation, blood glucose level, and so on. In some embodiments, the circuitry 124 may be configured to convey the determined or extracted parameters, inputs, or statuses via an output device of the device 100. For example, the circuitry 124 may cause the indication(s) to be displayed on the display 108, indicated via audio or haptic outputs, transmitted via a wireless communications interface or other communications interface, and so on. The circuitry 124 may also or alternatively maintain or alter one or more settings, functions, or aspects of the device 100, including, in some cases, what is displayed on the display 108.

In some embodiments, one of the assemblies described herein for optically sensing translational and rotational shaft movements may be associated with the crown 118. The assembly may be used, for example, to determine whether the crown 118 has been rotated, how much the crown 118 has been rotated, how fast the crown 118 has been rotated, whether the crown 118 has been pressed (or pulled), and so on.

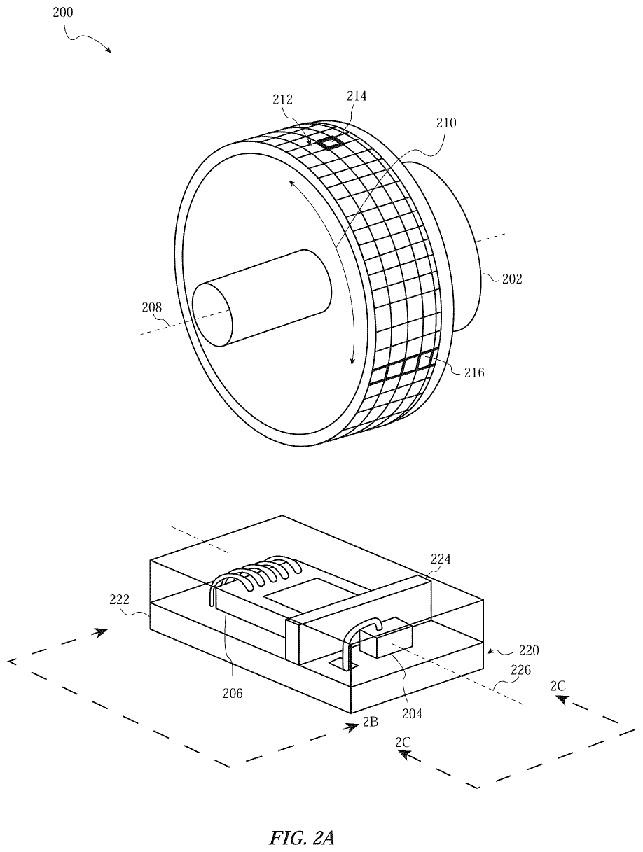

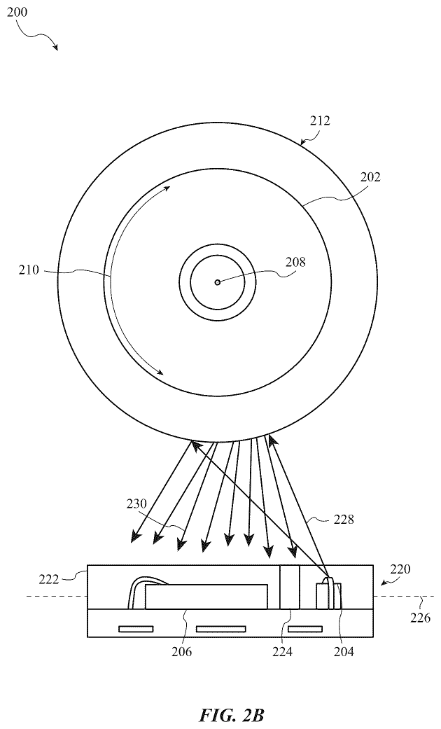

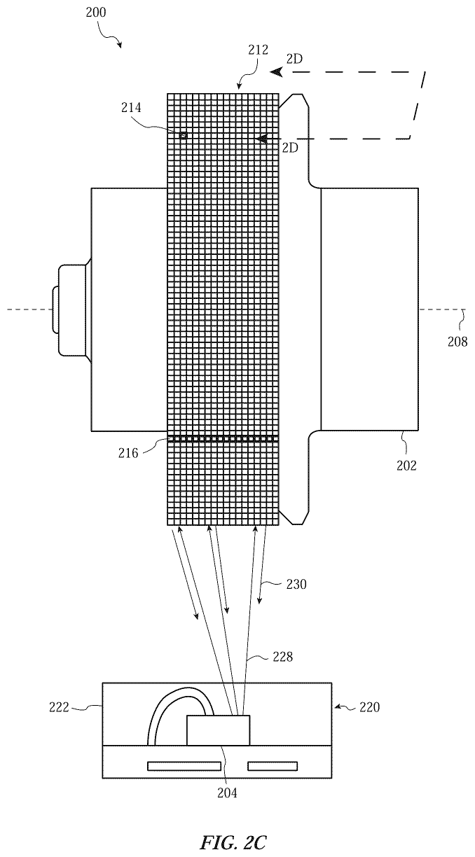

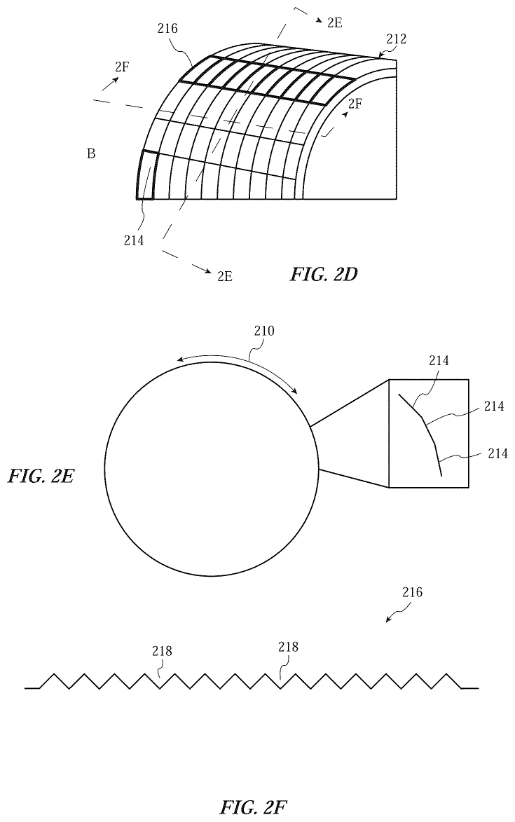

FIGS. 2A-2F show an example assembly 200 including a shaft 202, an optical emitter 204, and an optical receiver 206. FIG. 2A shows an isometric view of the assembly 200. FIG. 2B shows a first elevation of the assembly 200, from view 2B-2B in FIG. 2A. FIG. 2C shows a second elevation of the assembly 200, from view 2C-2C in FIG. 2A. FIG. 2D shows an isometric view of a portion of an optical encoder pattern 212 on a circumference 210 of the shaft 202, from view 2D-2D of FIG. 2C. FIG. 2E illustrates a portion of the optical encoder pattern 212, from view 2E-2E in FIG. 2D. FIG. 2F illustrates a portion of the optical encoder pattern 212, from view 2F-2F in FIG. 2D.

Turning to FIGS. 2A-2C, and in some embodiments, the shaft 202 may be a shaft of a rotatable and translatable input device, such as a shaft of a crown, button, dial, or knob. The input device may be provided on a wearable device (e.g., a wrist-worn device, headset, or earphones), a game controller, a dashboard, or any other type of device (e.g., another type of portable, wearable, movable, or stationary device). In some embodiments, the shaft 202 may be a shaft of the crown described with reference to FIGS. 1A and 1B. In some embodiments, the shaft 202 may be a shaft of a machine or engine.

The shaft 202 may be supported, at least in part, by a housing through which the shaft 202 extends, or by a support member, sleeve, or bearing through which the shaft 202 extends, or by a support member that cradles or otherwise supports the shaft 202. The optical emitter 204 and optical receiver 206 may be supported by the same housing that supports the shaft 202, or by a different housing, or by a printed circuit board, flexible circuit, or other structure to which the optical emitter 204 and optical receiver 206 are attached.

The shaft 202 (which in some cases may be part of an input device) may be rotatable and translatable with respect to an axis of rotation 208. For example, the shaft 202 may rotate about the axis of rotation 208 and translate along the axis of rotation 208. The shaft 202 may have a circumference 210 and an optical encoder pattern 212 (e.g., an engineered optical surface) disposed around the circumference 210. See FIGS. 2A, 2C, and 2D. In some embodiments, the optical encoder pattern 212 may include a series of polygon facets 214 about the circumference 210 (see, FIGS. 2C-2E), and a one-dimensional (1D) substantially retroreflective feature 216 parallel to the axis of rotation 208 (see FIGS. 2C, 2D, and 2F).

A retroreflective feature is a feature that reflects an incident photon in a direction that is parallel to the direction from which the photon is received (and sometimes, though not always, in a direction that is diametrically opposed to the direction from which the photon is received). A 1D retroreflective feature is a feature that reflects an incident photon in a direction that lies within a plane parallel to the direction from which the photon is received (and sometimes, though not always, within a plane including the direction from which the photon is received). As defined herein, a 1D substantially retroreflective feature 216 is a feature that is retroreflective, or close enough to retroreflective, that at least some reflected photons (but not necessarily all reflected photons) will be returned in a direction that lies within a plane parallel to the direction from which the photon is received, or within a plane that intersects the plane parallel to the direction from which the photon is received, with the angle of intersection preferably being less than 10 degrees (10°), less than 5°, less than 2°, or less than 1°. Preferably, although not required, all or a majority of the plane(s) within which a photon may be reflected by the 1D substantially retroreflective feature 216 should intersect an electromagnetic radiation receiving surface of the optical receiver 206. In some embodiments, the 1D substantially retroreflective feature 216 may include a 1D array of roof prism mirrors 218, as shown in FIG. 2F. In some embodiments, each roof prism mirror 218 in the array of roof prism mirrors 218 may have a same set of dimensions (e.g., same lengths of roof surfaces and same angles between adjacent roof surfaces). In some embodiments, different roof prism mirrors may have different sets of dimensions.

The optical emitter 204 and optical receiver 206 may be provided in a module 220 but may alternatively be separately provided. The module 220 includes a housing 222, and the housing 222 may, in some embodiments, include a light blocking wall 224. In embodiments that include the light blocking wall 224, the optical emitter 204 and optical receiver 206 may be carried by the housing 222 and positioned on opposite sides of the light blocking wall 224. The light blocking wall 224 (in some cases in combination with other light blocking walls or aspects of the housing 222) may reduce optical crosstalk between the optical emitter 204 and optical receiver 206 and help ensure that electromagnetic radiation emitted by the optical emitter 204 impinges on the optical encoder pattern 212 before impinging on the optical receiver 206.

In some embodiments, the module 220 may be attached to a printed circuit board, flexible circuit, or other substrate. In some embodiments, the optical emitter 204 and optical receiver 206 may be separately attached to a printed circuit board, flexible circuit, or other substrate. The optical emitter 204 and optical receiver 206 may be disposed along a sensing axis 226 that is orthogonal (or transverse) to the axis of rotation 208, as shown in FIGS. 2A and 2B (in contrast to the sensing axes of typical sensors, which are parallel to the axis of rotation 208 and often require an optical encoder pattern having a greater axial width).

The optical emitter 204 may be configured (e.g., positioned and oriented) to emit electromagnetic radiation 228 toward the optical encoder pattern 212. In some embodiments, the electromagnetic radiation 228 includes infrared (IR) electromagnetic radiation, though the electromagnetic radiation may additionally, or alternatively, include other wavelengths of electromagnetic radiation. In some embodiments, the optical emitter 204 may include a wide angle and incoherent optical emitter, such as a light-emitting diode (LED), though the optical emitter 204 may also include a laser diode or other type of optical emitter.

The optical receiver 206 may be configured (e.g., positioned and oriented) to receive reflections 230 of the emitted electromagnetic radiation from the optical encoder pattern 212 and generate an irradiance pattern in response to the reflections 230. The optical receiver 206 may include a two-dimensional (2D) array of pixels. In some embodiments, the array of pixels may be a 4×2, 4×4, 8×4, or 8×8 array of pixels. Movements or changes in the irradiance pattern along the first dimension may be primarily used to determine a rotation of the shaft 202. Movements or changes in the irradiance pattern along the second dimension may be primarily used to determine a translation of the shaft 202.

In some embodiments, the optical receiver 206 may generate a heat map of the electromagnetic radiation that is reflected form the optical encoder pattern 212 and returned to the optical receiver 206. In some embodiments, the optical receiver 206 may be a digital imager. For example, the optical receiver 206 may include a single-photon avalanche diode (SPAD) array (e.g., each pixel of the optical receiver 206 may include a SPAD). In some embodiments, the optical receiver 206 may be an analog imager. For example, the optical receiver 206 may be a complimentary metal-oxide semiconductor (CMOS) image sensor. A digital imager, such as a SPAD array, may be advantageous to an analog imager, such as a CMOS image sensor, in that it may be associated with faster readout circuitry that occupies less space.

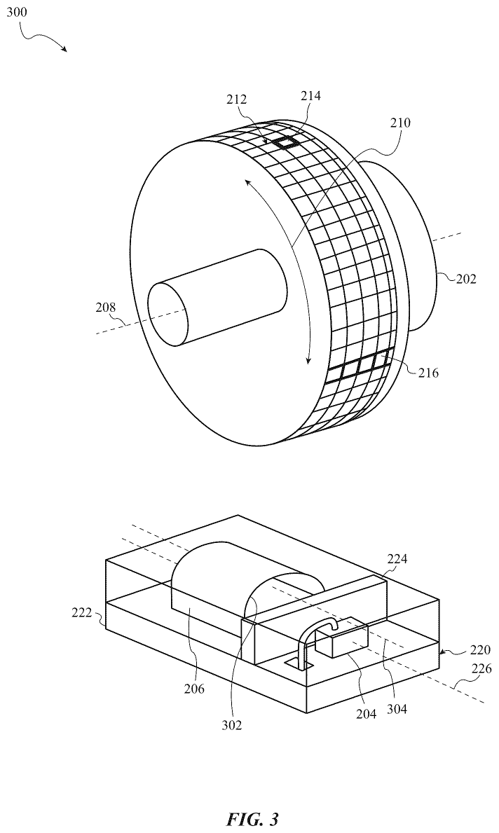

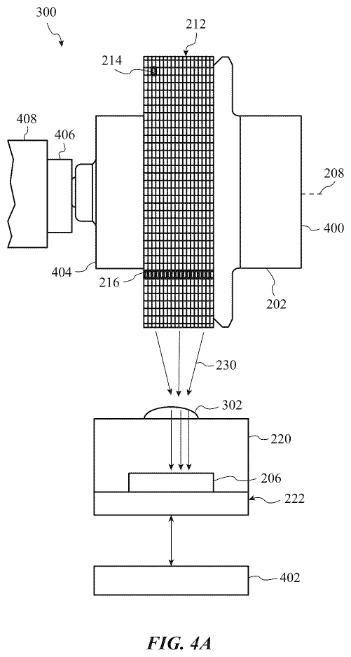

FIG. 3 shows an example optical element 302 disposed between a shaft 202 (e.g., an input device) and an optical receiver 206 of a first example assembly 300 for optically sensing translational and rotational shaft movements. The assembly 300 may be generally configured as described with reference to FIGS. 2A-2F, and like or similar components or elements are identified using the reference numerals introduced with reference to FIGS. 2A-2F.

The optical element 302 may be configured to convert an angular change of a retroreflection from the optical encoder pattern 212, resulting from a translation of the shaft 202 along the axis of rotation 208, to a change of a spatial position of the retroreflection on the optical receiver 206. In some embodiments, the optical element 302 may include a cylindrical lens having a power axis 304 oriented parallel to the sensing axis 226. In some embodiments, the optical element 302 may be suspended over the optical receiver 206 by the housing 222, as shown. Alternatively, the optical element 302 may be overmolded on the optical receiver 206 (i.e., formed directly on the optical receiver 206 instead of being spaced apart from the optical receiver 206).

In alternative embodiments, the optical element 302 may include a Fresnel lens, a 1D microlens array, a cylindrical lens array, a diffractive element, or another type of optical element that converts an angular optical reception of a retroreflection into a change of spatial position of the retroreflection on the optical receiver 206.

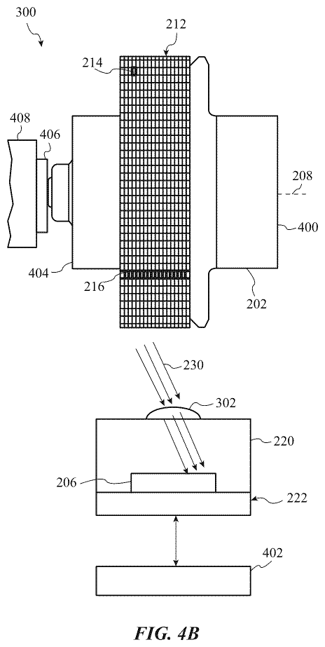

FIGS. 4A and 4B show elevations of the first example assembly 300 for optically sensing translational and rotational shaft movements. FIG. 4A shows the shaft 202 of the assembly 300 in a first translation position, and FIG. 4B shows the shaft 202 in a second translation position.

In FIG. 4A, the shaft 202 is in a right-most position. In FIG. 4B, the shaft 202 is in a left-most position. If the shaft 202 is included in a wearable device and biased to the right-most position shown in FIG. 4A (e.g., by a spring or other bias member), then the left-most position shown in FIG. 4B may be achieved by means of a user applying a force to (e.g., pressing) the right-most end 400 of the shaft 202. If the shaft 202 is included in a wearable device and biased to the left-most position shown in FIG. 4B (e.g., by a spring or other bias member), then the right-most position shown in FIG. 4A may be achieved by means of a user applying a force to (e.g., pulling) the right-most end 400 of the shaft 202. In other embodiments, the shaft 202 may not be biased to one position or another, and detents and nubs or the like, on or adjacent to the shaft 202, may temporarily retain the shaft in a position to which it is moved. In other embodiments, the shaft 202 may be moved by a machine, for example, and the optical receiver 206 may be used to confirm that the shaft 202 is where it is supposed to be at one or more sample times.

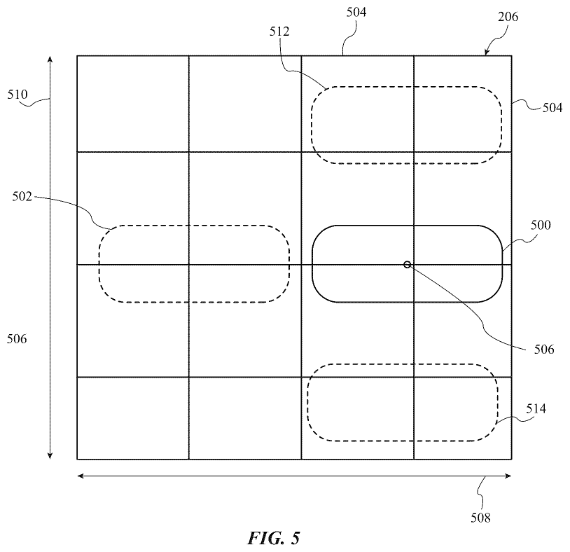

When the optical emitter 204 emits electromagnetic radiation toward the optical encoder pattern 212, a portion of the electromagnetic radiation may be reflected toward the optical receiver 206 and produce an irradiance pattern. An example irradiance pattern 500 is shown in FIG. 5. The irradiance pattern 500 is shown with respect to a surface of the optical receiver 206. By way of example, the optical receiver 206 is shown to have a 4×4 array of pixels 504.

The irradiance pattern 500 may correspond with the shaft 202 being in the translation position shown in FIG. 4A. When the shaft 202 is moved to the translation position shown in FIG. 4B, the irradiance pattern 500 may change to the irradiance pattern 502 (shown in phantom). The irradiance pattern 500 has a centroid 506 that moves along a first axis 508 with respect to the 2D array of pixels 504 in response to a translation of the shaft 202 along the axis of rotation 208. In contrast, the irradiance pattern 500 may move along a second axis 510 with respect to the 2D array of pixels 504 in response to a rotation of the shaft 202 about the axis of rotation 208 (e.g., the irradiance pattern 500 may change to the irradiance pattern 512 or 514 as the shaft 202 is rotated).

In some embodiments, an output of the optical receiver 206 may be received by circuitry 402 (e.g., an analog circuit, a digital circuit, and/or a processor; see, e.g., FIGS. 4A and 4B) that is coupled to the optical receiver 206. The coupling may be direct (e.g., by means of the circuitry 402 including a sense amplifier or analog-to-digital converter (ADC) that receives the output of the optical receiver 206) or indirect (e.g., to a memory that stores a digital representation of the output of the optical receiver 206). The circuitry 402 may be configured, for example, to determine a location of the centroid 506 of the irradiance pattern 500 along the first axis 508, and to correlate the location of the centroid 506 of the irradiance pattern 500 along the first axis 508 with the translation position of the shaft 202 along the axis of rotation 208.

The circuitry 402 may also be configured, for example, to determine a position of the irradiance pattern 500 along the second axis 510, and to correlate the position of the irradiance pattern 500 along the second axis 510 with the rotation position of the shaft 202 about the axis of rotation 208. In essence, the optical emitter 204, optical encoder pattern 212, optical receiver 206, and circuitry 402 operate as an image phase encoder for rotation tracking.

In some embodiments, the circuitry 402 may be configured to simultaneously determine a translation position and a rotation position of the shaft 202 (although the circuitry 402 could alternatively determine one position and then the other position, or only one position or the other position).

Depending on the number and/or type of pixels included in the optical receiver 206, the output of the optical receiver 206 may in some cases be used by the circuitry 402 to determine more than two translation positions of the shaft 202. If the shaft 202 is biased by an optional compliant material or compliant member (e.g., a compliant material 406 positioned between an immovable housing member 408 and a left-most end 404 of the shaft 202; see FIGS. 4A and 4B), the circuitry 402 may correlate the location of the centroid 506 of the irradiance pattern 500 along the first axis 508 with not only the translation position of the shaft 202 along the axis of rotation 208, but also an amount of force applied to the shaft 202. In some embodiments, the compliant material 406 or compliant member may include silicone, a spring, foam, or another type of material or member.

In some embodiments, the circuitry 402 may determine other aspects of shaft translation based on movement of the centroid 506 of the irradiance pattern 500 along the first axis 508, such as the duration of a press, a predetermined sequence of presses (e.g., a double press), and so on.

The circuitry 402 may also be coupled to the optical emitter 204, and may drive the optical emitter 204, convert signals generated by the optical receiver 206 into digital counts, speed, or direction information, and/or perform other operations.

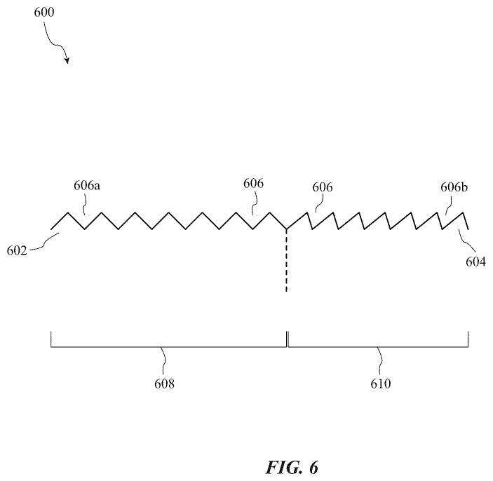

FIG. 6 shows an example profile of a 1D substantially retroreflective feature 600 for a second example assembly for optically sensing translational and rotational shaft movements.

In contrast to the profile of the 1D substantially retroreflective feature shown in FIG. 2F, which has a regularly repeating periodic structure, the profile of the 1D substantially retroreflective feature 600 has an axial perturbation from a first end 602 of the feature 600 to a second end 604 of the feature 600 (e.g., a change in dihedral bias between different subsets of roof prism mirrors).

By way of example, the 1D substantially retroreflective feature 600 includes a 1D array of roof prism mirrors 606 extending from a first position along the axis of rotation 208 (e.g., the first end 602 of the feature 600) to a second position along the axis of rotation 208 (e.g., the second end 604 of the feature 600). The 1D array of roof prism mirrors 606 may include a first roof prism mirror 606a that is closer to the first position (e.g., the first end 602 of the feature 600) than a second roof prism mirror 606b, and the first and second roof prism mirrors 606a, 606b may have different sets of dimensions (e.g., different lengths of roof surfaces and/or different angles between adjacent roof surfaces). In some embodiments, a first subset 608 of the roof prism mirrors may have a first set of dimensions (e.g., the dimensions of the first roof prism mirror 606a), and a second subset 610 of the roof prism mirrors may have a second set of dimensions (e.g., the dimensions of the second roof prism mirror 606b). In some embodiments, the first subset 608 of roof prism mirrors may have dimensions that make them retroreflective, and the second subset 610 of roof prism mirrors may have dimensions that make them not quite retroreflective (e.g., the dihedral angle between adjacent roof surfaces of the second subset 610 of roof prism mirrors may be more than 0° but less than 10°, less than 5°, less than 2°, or less than 1° less than or greater than 90°).

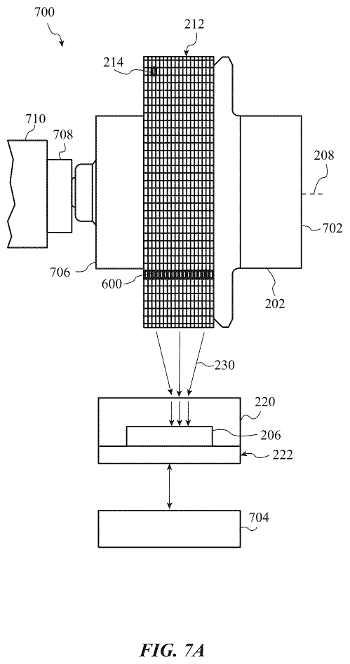

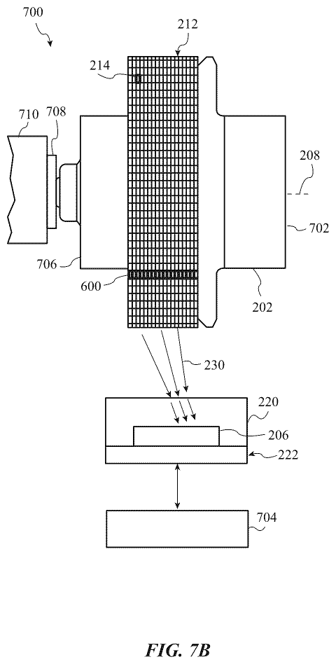

FIGS. 7A and 7B show elevations of the second example assembly 700 for optically sensing translational and rotational shaft movements. The second example assembly may be generally configured as described with reference to FIGS. 2A-2F, and like or similar components or elements are identified using the reference numerals introduced with reference to FIGS. 2A-2F. FIG. 7A shows a shaft 202 of the assembly 700 in a first translation position, and FIG. 7B shows the shaft in a second translation position. The optical encoder pattern 212 may include the 1D substantially retroreflective feature 600 described with reference to FIG. 6.

In FIG. 7A, the shaft 202 is in a right-most position. In FIG. 7B, the shaft 202 is in a left-most position. If the shaft 202 is included in a wearable device and biased to the right-most position shown in FIG. 7A (e.g., by a spring or other bias member), then the left-most position shown in FIG. 7B may be achieved by means of a user applying a force to (e.g., pressing) the right-most end 702 of the shaft 202. If the shaft 202 is included in a wearable device and biased to the left-most position shown in FIG. 7B (e.g., by a spring or other bias member), then the right-most position shown in FIG. 7A may be achieved by means of a user applying a force to (e.g., pulling) the right-most end 702 of the shaft 202. In other embodiments, the shaft 202 may not be biased to one position or another, and detents and nubs or the like, on or adjacent the shaft 202, may temporarily retain the shaft in a position to which it is moved. In other embodiments, the shaft 202 may be moved by a machine, for example, and the optical receiver 206 may be used to confirm that the shaft 202 is where it is supposed to be at one or more sample times.

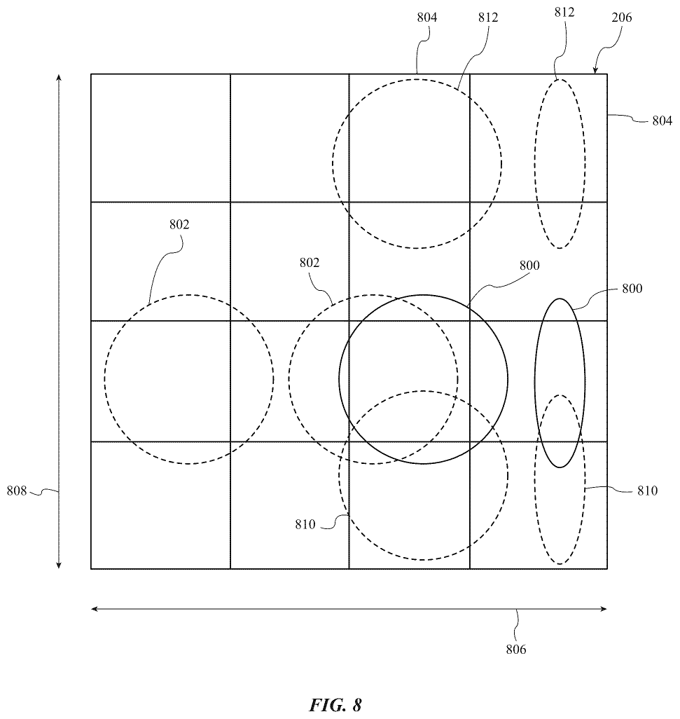

When the optical emitter 204 emits electromagnetic radiation toward the optical encoder pattern 212, a portion of the electromagnetic radiation may be reflected toward the optical receiver 206 and produce an irradiance pattern. An example irradiance pattern 800 is shown in FIG. 8. The irradiance pattern 800 is shown with respect to a surface of the optical receiver 206. By way of example, the optical receiver 206 is shown to have a 4×4 array of pixels 804.

The irradiance pattern 800 may correspond with the shaft 202 being in the translation position shown in FIG. 7A. When the shaft 202 is moved to the translation position shown in FIG. 7B, the irradiance pattern 800 may change to the irradiance pattern 802 (shown in phantom). The irradiance pattern 800 has an electromagnetic radiation distribution (or pattern, or shape) that changes along a first axis 806 with respect to the 2D array of pixels 804 in response to a translation of the shaft 202 along the axis of rotation 208. In contrast, the irradiance pattern 800 may move along a second axis 808 with respect to the 2D array of pixels 804 in response to a rotation of the shaft 202 about the axis of rotation 208 (e.g., the irradiance pattern 800 may change to the irradiance pattern 810 or 812 as the shaft 202 is rotated).

In some embodiments, an output of the optical receiver 206 may be received by circuitry 704 (e.g., an analog circuit, a digital circuit, and/or a processor; see, e.g., FIGS. 7A and 7B) that is coupled to the optical receiver 206. The coupling may be direct (e.g., by means of the circuitry 704 including a sense amplifier or ADC that receives the output of the optical receiver 206) or indirect (e.g., to a memory that stores a digital representation of the output of the optical receiver 206). The circuitry 704 may be configured, for example, to determine the electromagnetic radiation distribution of the irradiance pattern 800 along the first axis 806, and to correlate the electromagnetic radiation distribution of the irradiance pattern 800 along the first axis 806 with the translation position of the shaft 202 along the axis of rotation 208. In some embodiments, the circuitry 704 may be configured to identify a magnitude of a first peak of the electromagnetic radiation distribution; identify a second magnitude of a second peak of the electromagnetic radiation distribution; determine a ratio of the magnitude of the first peak to the magnitude of the second peak; and use the ratio to correlate the electromagnetic radiation distribution of the irradiance pattern 800 along the first axis 806 with the translation position of the shaft 202 along the axis of rotation 208.

The circuitry 704 may also be configured, for example, to determine a position of the irradiance pattern 800 along the second axis 808, and to correlate the position of the irradiance pattern 800 along the second axis 808 with the rotation position of the shaft 202 about the axis of rotation 208. In essence, the optical emitter 204, optical encoder pattern 212, optical receiver 206, and circuitry 704 operate as an image phase encoder for rotation tracking.

In some embodiments, the circuitry 704 may be configured to simultaneously determine a translation position and a rotation position of the shaft 202 (although the circuitry 704 could alternatively determine one position and then the other position, or only one position or the other position).

Depending on the number and/or type of pixels included in the optical receiver 206, the output of the optical receiver 206 may in some cases be used by the circuitry 704 to determine more than two translation positions of the shaft 202. If the shaft 202 is biased by an optional compliant material or compliant member (e.g., a compliant material 708 positioned between an immovable housing member 710 and a left-most end 706 of the shaft 202; see FIGS. 7A and 7B), the circuitry 704 may correlate the electromagnetic radiation distribution of the irradiance pattern 800 along the first axis 806 with not only the translation position of the shaft 202 along the axis of rotation 208, but also an amount of force applied to the shaft 202. In some embodiments, the compliant material 708 or compliant member may include silicone, a spring, foam, or another type of material or member.

In some embodiments, the circuitry 704 may determine other aspects of shaft translation based on movement of the electromagnetic radiation distribution of the irradiance pattern 800 along the first axis 806, such as the duration of a press, a predetermined sequence of presses (e.g., a double press), and so on.

The circuitry 704 may also be coupled to the optical emitter 204, and may drive the optical emitter 204, convert signals generated by the optical receiver 206 into digital counts, speed, or direction information, and/or perform other operations.

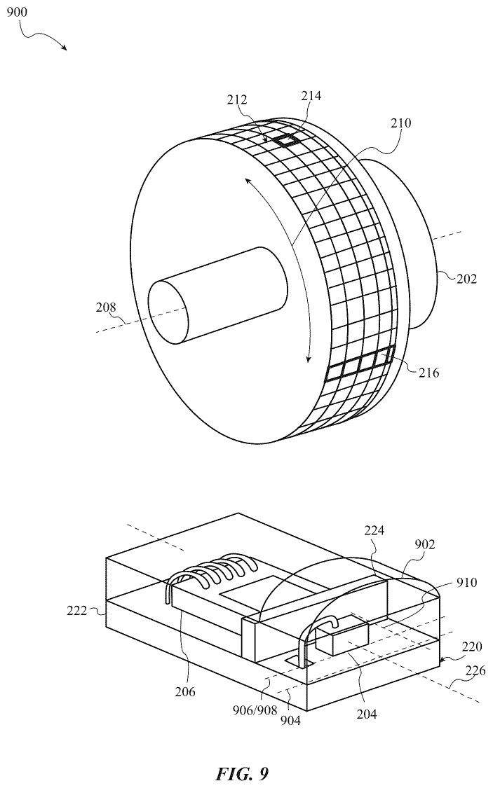

FIG. 9 shows an example optical element 902 disposed between an optical emitter 204 and a shaft 202 of a third example assembly 900 for optically sensing translational and rotational shaft movements. The assembly 900 may be generally configured as described with reference to FIGS. 2A-2F, and like or similar components or elements are identified using the reference numerals introduced with reference to FIGS. 2A-2F.

The optical element 902 may be configured to produce a virtual optical emission plane 904 for the optical emitter 204. In some embodiments, the optical element 902 may include a cylindrical lens having a power axis 910 oriented parallel to the sensing axis 226. The virtual optical emission plane 904 may differ from an actual optical emission plane 906 of the optical emitter 204 and may differ from an image plane 908 of the optical receiver 206. The actual optical emission plane 906 and the image plane 908 may be the same plane. In some embodiments, the optical element 902 may include a spherical lens. In some embodiments, the optical element 902 may include a cylindrical lens or other type of optical element. In some embodiments, the optical element 902 may be suspended over the optical emitter 204 by the housing 222, as shown. Alternatively, the optical element 902 may be overmolded on the optical emitter 204 (i.e., formed directly on the optical emitter 204 instead of being spaced apart from the optical emitter 204).

The optical element 902 causes the 1D substantially retroreflective feature 216 to return reflected electromagnetic radiation to the virtual optical emission plane 904. However, such a reflection is received at different spatial positions on the surface of the optical receiver 206, depending on a translation position of the shaft 202. The spatial position can be correlated to a translation position of the shaft 202 as described with reference to FIGS. 4A, 4B and 5.

As an alternative to what is shown in FIG. 9, the actual optical emission plane 906 of the optical emitter 204 or the image plane 908 of the optical receiver 206 may be physically shifted. For example, the optical emitter 204 or the optical receiver 206 may be mounted on a pedestal to provide an actual offset (instead of a virtual offset) between the actual optical emission plane 906 and the image plane 908. This also causes the 1D substantially retroreflective feature 216 to return reflected electromagnetic radiation to different spatial positions on the surface of the optical receiver 206, depending on a translation position of the shaft 202.

In some embodiments, optical elements may be provided between the optical emitter 204 and the shaft 202, and between the shaft 202 and the optical receiver 206, to accentuate the shift in spatial position of an irradiance pattern on the optical receiver 206 as a result of shaft translation. In some embodiments, the optical element between the optical emitter 204 and the shaft 202 may include a cylindrical lens having a power axis 910 oriented parallel to the sensing axis 226, and the optical element between the shaft 202 and the optical receiver 206 may include a concave lens having its power axis oriented parallel to the sensing axis 226.

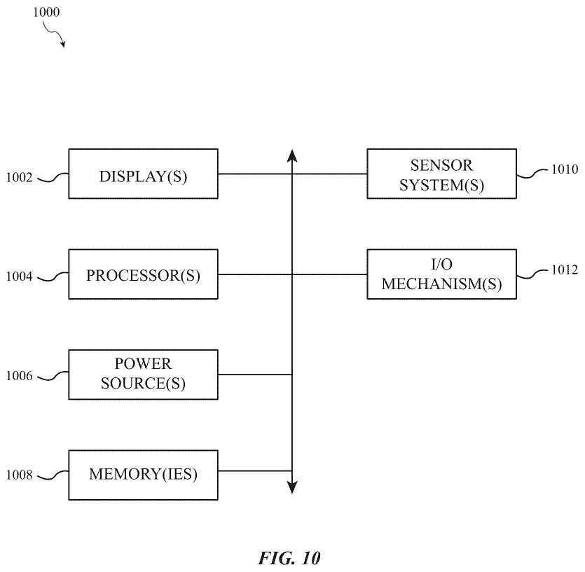

FIG. 10 shows a sample electrical block diagram of an electronic device 1000, which electronic device 1000 may in some cases be the electronic device described with reference to FIGS. 1A and 1B, or any of the other devices described herein. The electronic device 1000 may include an assembly for optically sensing translational and rotational movements of an input device, as described with reference to any of FIGS. 1A-9. The electronic device 1000 may optionally include an electronic display 1002 (e.g., a light-emitting display), a processor 1004, a power source 1006, a memory 1008 or storage device, a sensor system 1010, and/or an input/output (I/O) mechanism 1012 (e.g., an input/output device, input/output port, or haptic input/output interface). The processor 1004 may control some or all of the operations of the electronic device 1000. The processor 1004 may communicate, either directly or indirectly, with some or all of the other components of the electronic device 1000. For example, a system bus or other communication mechanism 1014 can provide communication between the electronic display 1002, the processor 1004, the power source 1006, the memory 1008, the sensor system 1010, and the I/O mechanism 1012.

The processor 1004 may be implemented as any electronic device capable of processing, receiving, or transmitting data or instructions, whether such data or instructions is in the form of software or firmware or otherwise encoded. For example, the processor 1004 may include a microprocessor, a central processing unit (CPU), an application-specific integrated circuit (ASIC), a digital signal processor (DSP), a control circuit, or a combination of such devices. As described herein, the term “processor” is meant to encompass a single processor or processing unit, multiple processors, multiple processing units, or other suitably configured computing element or elements. In some cases, the processor 1004 may provide part or all of the processing system or processor described herein.

It should be noted that the components of the electronic device 1000 can be controlled by multiple processors. For example, select components of the electronic device 1000 (e.g., the sensor system 1010) may be controlled by a first processor and other components of the electronic device 1000 (e.g., the electronic display 1002) may be controlled by a second processor, where the first and second processors may or may not be in communication with each other.

The power source 1006 can be implemented with any device capable of providing energy to the electronic device 1000. For example, the power source 1006 may include one or more batteries or rechargeable batteries. Additionally, or alternatively, the power source 1006 may include a power connector or power cord that connects the electronic device 1000 to another power source, such as a wall outlet. The power source 1006 may also include a wireless charging circuit.

The memory 1008 may store electronic data that can be used by the electronic device 1000. For example, the memory 1008 may store electrical data or content such as, for example, audio and video files, documents and applications, device settings and user preferences, timing signals, control signals, instructions, and/or data structures or databases. The memory 1008 may include any type of memory. By way of example only, the memory 1008 may include random access memory, read-only memory, Flash memory, removable memory, other types of storage elements, or combinations of such memory types.

The electronic device 1000 may also include one or more sensor systems 1010 positioned almost anywhere on the electronic device 1000. The sensor system(s) 1010 may be configured to sense one or more types of parameters, such as but not limited to: vibration, light, touch, force, heat, movement, relative motion, biometric data (e.g., biological parameters) of a user, air quality, proximity, position, connectedness, surface quality, and so on. By way of example, the sensor system(s) 1010 may include a heat sensor, a position sensor, a light or optical sensor, an accelerometer, a pressure transducer, a gyroscope, a magnetometer, a health monitoring sensor, and an air quality sensor, and so on. Additionally, the one or more sensor systems 1010 may utilize any suitable sensing technology, including, but not limited to, interferometric, magnetic, capacitive, ultrasonic, resistive, optical, acoustic, piezoelectric, or thermal technologies.

The I/O mechanism 1012 may transmit or receive data from a user or another electronic device. The I/O mechanism 1012 may include the electronic display 1002, a touch sensing input surface, a crown (e.g., a crown associated with an assembly for optically sensing translational and rotational movements of an input device, as described with any of FIGS. 1A-9), one or more buttons (e.g., a graphical user interface “home” button), one or more cameras (including an under-display camera), one or more microphones or speakers, one or more ports such as a microphone port, and/or a keyboard. Additionally, or alternatively, the I/O mechanism 1012 may transmit electronic signals via a communications interface, such as a wireless, wired, and/or optical communications interface. Examples of wireless and wired communications interfaces include, but are not limited to, cellular and Wi-Fi communications interfaces.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. An assembly for an electronic device, comprising:
a rotatable and translatable input device having an axis of rotation, a circumference about the axis of rotation, and an optical encoder pattern disposed around the circumference, the optical encoder pattern including a series of polygon facets about the circumference and a one-dimensional (1D) substantially retroreflective feature parallel to the axis of rotation;
an optical emitter configured to emit electromagnetic radiation toward the optical encoder pattern; and
an optical receiver including a two-dimensional (2D) array of pixels, the optical receiver configured to receive reflections of the emitted electromagnetic radiation from the optical encoder pattern and generate an irradiance pattern in response to the reflections, the optical emitter and the optical receiver disposed along a sensing axis orthogonal to the axis of rotation.

2. The assembly of claim 1, further comprising:
an optical element disposed between the rotatable and translatable input device and the optical receiver, the optical element configured to convert an angular change of a retroreflection from the optical encoder pattern, resulting from a translation of the input device, to a change of a spatial position of the retroreflection on the optical receiver.

3. The assembly of claim 2, wherein the optical element is a cylindrical lens having a power axis oriented parallel to the sensing axis.

4. The assembly of claim 2, wherein the optical element is overmolded on the optical receiver.

5. The assembly of claim 2, further comprising:
a housing including a light blocking wall; wherein,
the optical emitter and the optical receiver are carried by the housing and positioned on opposite sides of the light blocking wall; and
the optical element is suspended over the optical receiver by the housing.

6. The assembly of claim 1, wherein the one-dimensional substantially retroreflective feature comprises a 1D array of roof prism mirrors, each roof prism mirror in the 1D array of roof prism mirrors having a same set of dimensions.

7. The assembly of claim 1, wherein the one-dimensional substantially retroreflective feature has an axial perturbation from a first end of the 1D substantially retroreflective feature to a second end of the 1D substantially retroreflective feature.

8. The assembly of claim 1, wherein:
the one-dimensional substantially retroreflective feature comprises a one-dimensional array of roof prism mirrors extending from a first position to a second position along the axis of rotation;
the one-dimensional array of roof prism mirrors comprises a first roof prism mirror closer to the first position than a second roof prism mirror; and
the first roof prism mirror has a different set of dimensions than the second roof prism mirror.

9. The assembly of claim 1, further comprising:
an optical element disposed between the optical emitter and the rotatable and translatable input device, the optical element configured to produce a virtual optical emission plane for the optical emitter, the virtual optical emission plane differing from an actual optical emission plane of the optical emitter and an image plane of the optical receiver.

10. The assembly of claim 1, wherein an optical emission plane of the optical emitter differs from an image plane of the optical receiver.

11. The assembly of claim 1, wherein the optical emitter comprises a light-emitting diode (LED).

12. The assembly of claim 1, wherein each pixel in the two-dimensional array of pixels comprises a single-photon avalanche diode (SPAD).

13. An assembly for an electronic device, comprising:
a rotatable and translatable shaft having an optical encoder pattern disposed around a circumference of the shaft;
an optical emitter configured to emit electromagnetic radiation toward the optical encoder pattern; and
an optical receiver including a two-dimensional (2D) array of pixels, the optical receiver configured to receive reflections of the emitted electromagnetic radiation from the optical encoder pattern and generate an irradiance pattern in response to the reflections, the irradiance pattern having a centroid that moves along a first axis with respect to the two-dimensional array of pixels in response to a translation of the shaft along an axis of rotation, and the irradiance pattern moving along a second axis with respect to the two-dimensional array of pixels in response to a rotation of the shaft about the axis of rotation.

14. The assembly of claim 13, further comprising:
circuitry coupled to the optical receiver and configured to,
determine a location of the centroid of the irradiance pattern along the first axis; and
correlate the location of the centroid of the irradiance pattern along the first axis with a translation position of the shaft along the axis of rotation.

15. The assembly of claim 14, wherein:
the circuitry is further configured to,
determine a position of the irradiance pattern along the second axis; and
correlate the position of the irradiance pattern along the second axis with a rotation position of the shaft about the axis of rotation.

16. The assembly of claim 13, wherein the electromagnetic radiation comprises infrared electromagnetic radiation.

17. An assembly for an electronic device, comprising:
a rotatable and translatable shaft having an optical encoder pattern disposed around a circumference of the shaft;
an optical emitter configured to emit electromagnetic radiation toward the optical encoder pattern; and
an optical receiver including a two-dimensional (2D) array of pixels, the optical receiver configured to receive reflections of the emitted electromagnetic radiation from the optical encoder pattern and generate an irradiance pattern in response to the reflections, the irradiance pattern having an electromagnetic radiation distribution that changes along a first axis with respect to the two-dimensional array of pixels in response to a translation of the shaft along an axis of rotation, and the irradiance pattern moving along a second axis with respect to the two-dimensional array of pixels in response to a rotation of the shaft about the axis of rotation.

18. The assembly of claim 17, further comprising:
circuitry coupled to the optical receiver and configured to,
determine the electromagnetic radiation distribution of the irradiance pattern along the first axis; and
correlate the electromagnetic radiation distribution of the irradiance pattern along the first axis with a translation position of the shaft along the axis of rotation.

19. The assembly of claim 18, wherein:
the circuitry is further configured to,
identify a magnitude of a first peak of the electromagnetic radiation distribution;
identify a second magnitude of a second peak of the electromagnetic radiation distribution;
determine a ratio of the magnitude of the first peak to the magnitude of the second peak; and
use the ratio to correlate the electromagnetic radiation distribution of the irradiance pattern along the first axis with the translation position of the shaft along the axis of rotation.

20. The assembly of claim 18, wherein:
the circuitry is further configured to,
determine a position of the irradiance pattern along the second axis; and
correlate the position of the irradiance pattern along the second axis with a rotation position of the shaft about the axis of rotation.
